(19) United States
(12) Patent Application Publication
(10) Pub. No.: US 2005/0160942 A1
(43) Pub. Date: Jul. 28, 2005

(54) Moisture protection/retention coating for composite materials

(75) Inventor: Longin B. Greszczuk, Mission Viejo, CA (US)

Correspondence Address: Shaukat A. Karjeker;Steiner Norris, PLLC, Suite 2000, 2320 2nd Avenue, Seattle, WA, 98121, US

(73) Assignee: The Boeing Company, Chicago, IL (US)

(21) Appl. No.: 10/816,384

(22) Filed: Apr. 1, 2004

Related U.S. Application Data
(63) Continuation-in-part of application No. 10/766,702, filed on Jan. 28, 2004.

(51) Int. Cl. C08L 91/06

(52) U.S. Cl. 106/272; 106/285; 106/243

(57) ABSTRACT

A coating composition resistant to penetration by moisture that, when coated onto a composite containing residual moisture after cure, substantially prevents the loss of this residual moisture from the composite thus reducing the risk of cracking of the composite. The composition includes: a) a mixture of esters of fatty acids and aliphatic hydrocarbons having a melting point in the range from about 120° to about 180° F.; and b) a powdered additive in sufficient amount to permit uniform heating of a mass of the composition and to provide compression of a mass of the composition upon rapid cooling sufficient to substantially exclude occluded gasses from a cooled mass.

### STATEMENT OF RELATED APPLICATIONS

This application claims priority from commonly owned U.S. Ser. No. 10/766,702, filed Jan. 28, 2004

### BACKGROUND OF THE INVENTION

1. Field of the Invention

The invention relates to the field of coatings, and more particularly to the coating of composite materials prone to loss of moisture.

2. Description of the Related Art

Advanced lightweight structures made with composite materials are becoming increasingly important in a variety of applications, as processes for manufacture improve and as properties of these materials are better understood, and hence more readily customized for particular uses. Composites generally include a solid material (a filler or reinforcement that could be particulate, fibrous, or a woven or nonwoven oriented or non-oriented fiber material, etc.) incorporated into a matrix that most typically is an organic polymer. Additives of various kinds may be added to serve a variety of functions. Composites may form outer layers of a sandwich structure in which the inner core may be materials such as foam or a lightweight core, such as honeycomb core, to form a structured composite product, or they can be used to form monocoque or stiffened structures.

In its simplest aspect, engineering the properties of the composite depends upon appropriate selection of the reinforcement material and the matrix material. In a structured product, the structural configuration and core must also be carefully selected for the intended purpose of the product.

Engineered composites are used in the aerospace industry in a variety of structural applications, and are also finding use in other areas, for example the automobile and boat building industries, because they can be made lightweight, strong, and durable. Depending upon the nature of its use, the composite may be subject to harsh environmental conditions of temperature and humidity. Accordingly, it is desirable that the composite resist environmental effects and retain its mechanical properties.

### SUMMARY OF THE INVENTION

The invention provides a coating composition that, when applied to composites that contain residual moisture after curing, substantially reduces or prevents cracking from moisture loss under environmental conditions to which the composites are exposed.

In one embodiment, the coating composition of the invention substantially reduces moisture loss from the material, that is otherwise subject to moisture loss, with the resultant formation of cracks as it dries. This composition includes:
(a) a mixture of aliphatic hydrocarbons and esters of fatty acids, the mixture having a melting point in the range from about 120° to about 250° F.; and
(b) a powdered additive in sufficient amount to make the composition a rigid solid at ambient temperature, the amount of additive sufficient to permit rapid uniform heating of a mass of the composition, and during cooling of the liquid mass to a solid, the additive sufficient to provide compression of the mass to substantially exclude occluded gasses from the cooled mass.

The composition, in one embodiment, is a solid at ambient temperatures. However, it may be heated to liquefaction for ease of application as a coating to a substrate by spraying, by means of a roller or brush, or by other means ordinarily used to apply coatings. The powdered additive has the added advantage of preventing the build up of static electrical charge, when it is metallic.

The coatings of the invention preferably do not include solvents, and therefore do not pose environmental issues raised by evaporation of solvent (usually a volatile organic compound) into the atmosphere. The coatings of the invention are stable and long-lived, but they can be removed by application of heat to melt off the coatings, or a suitable solvent to dissolve the coatings, should the need arise. The coating compositions of the invention are non corrosive to typical composite and core materials, and so do not in themselves pose any hazards with respect to their physical properties. Relatively thin coatings are effective in preventing moisture loss, and so the coatings do not appreciably add weight to structure where weight is an important factor.

The foregoing represents a brief summary of advantages and features of the invention that is detailed in the discussion here below and from which a person of skill in the art will readily appreciate additional benefits and features of the invention.

### DETAILED DESCRIPTION OF THE PREFERRED EMBODIMENTS

Composites usually include a filler embedded in or coated with a matrix of an organic polymer or mixtures of polymers. The filler could be selected from powdered filler, fibrous filler, woven filler, non-woven filler, oriented fiber filler, and many other types available commercially. Other additives may be added for a variety of purposes, for example ultra violet inhibitors to retard ultraviolet light induced degradation of the composite matrix, color additives for aesthetic or other reasons, catalysts to facilitate cross linking of the matrix, and other additives for other purposes. The filler and matrix are selected to be compatible with each other and to provide desired physical properties. Composites may be fabricated into structural composites that include more than one type of material. For example, a structural composite might include a “sandwich” construction with outer thin layers of a composite covering a core of another material, such as a structured cellular material or a foam or balsa wood. Such lightweight composite materials can be used in a variety of applications, for example, aircraft cabin luggage bins, automobile interior panels, fairings for rocket launch vehicles, ship structures, airplane wings, and the like. Composites may also be used as monocoque and stiffened structures for applications such as motor cases, nozzles of launch vehicles, underwater structures, high pressure tanks, and like structural components and devices.

Certain polymers used as the matrix material, or as part of the matrix material in combination with other polymers, are known to produce water as a reaction product when the composite is “cured” under ordinary conditions of cure—usually application of heat and pressure. A residual amount of this water is held as moisture within the composite and the matrix material after cure. Non limiting examples of such composites are the glass/phenolic, graphite/phenolic composites as well as composites made with polyimide polymers and other condensation-type imids.

It has been found that certain composites are prone to cracking after cure, resulting in an often dramatic reduction in mechanical properties. In many cases the cracks appear some period of time after the composite was cured. It has been theorized (without being bound) that, since this phenomenon has been observed in composites that include in the polymeric matrix at least one polymer that produces water upon curing, the cracks may be due to loss of a residual amount of the moisture that the composite retains internally. In other words, it has been suggested that cracks begin to form in the composite due to “drying out” of the composite through loss of internal residual moisture under conditions of storage or use or both.

While not being bound by any theory, it is now believed that those cured composites that include polymers that produce moisture upon cure, have an internal moisture equilibrium. This equilibrium is affected by loss of moisture from exposed surfaces into the surroundings. The moisture loss at the surface causes migration of moisture to the surface from within the composite, in an effort to maintain the equilibrium, in accordance with Le Chatelier's principle. At some point, the loss of moisture is of such a magnitude, that the equlibrium cannot be maintained, and this leads to internal stresses within the composite material. The time period for such moisture loss-induced stresses to arise varies based on the type of material, and the environment to which it is exposed. Regardless of time, however, the loss of moisture causes cracking and thereby significantly degrades mechanical properties, often rendering the composite unsuitable for its intended purpose.

The invention solves the composite cracking problem by providing a coating composition that minimizes and/or virtually completely eliminates loss of residual moisture from composite surfaces covered with the composition. Thus, a composite will maintain its mechanical properties virtually unchanged, despite prolonged exposure to environmental conditions, as long as these conditions do not adversely affect the integrity of the coating or result in removal of the coating. For example, exposure to high temperatures might burn the coating, and exposure to solvents might remove the coating. In general, when properly applied and maintained, the coating composition will substantially prevent composite moisture loss. Thus, in most cases, the rate of moisture loss, or loss over a period of time, is reduced to at least about 50% compared to uncoated composites, and is preferably reduced by from about 60 to 100%. The composition in accordance with the invention includes a polymer mixture that includes hydrophobic organic compounds. More particularly, in one embodiment, these compounds are esters of fatty acids and aliphatic hydrocarbons, and an inorganic powder additive.

In one embodiment, the esters of fatty acids include waxes in the range of chain lengths typical of beeswax; and the aliphatic hydrocarbons include paraffins, primarily of carbon chain length C18 to C36, although other carbon chain lengths might also be present in smaller proportion.

Preferably, but not necessarily, the mixture of waxes and aliphatic hydrocarbons has a melting point in the range from about 120° (49° C.) to about 250° F. (121° C.), and more preferably from about 140° (60° C.) to about 180° F. (82° C.). Preferably, but not necessarily, the mixture is a relatively rigid stable solid at room temperature (about 75° F. (24° C.)).

An embodiment of the polymer mixture may be prepared by combining, in suitable proportions, components A and B, where A is yellow beeswax sold by Freeman Manufacturing & Supply of USA, and B is a paraffin sold by Eastman Kodak of USA. In this embodiment the ratio of A to B may vary from about 90:10 to about 10:90; but preferably about 70:30 to about 30:70 and most preferably, about 60 to about 40.

It has been found that a powdered inorganic material must be added to the mixture of aliphatic hydrocarbons to perform a function. Preferably, the powder is selected from powdered metal or metal oxide. The powdered material must be compatible with the polymers of the mixture, and have no deleterious side effects. When added into a molten mixture of the polymers, the additive assists in driving out entrapped air or other gasses, thereby reducing the incidence of occluded air in the composition. The powder also makes the solid more rigid, i.e. more stiff with increased hardness. Air or other gas bubbles in the coating will provide gaps for ingress of moisture and absorption into the composite. It has been found that certain metals and metal oxides provide the function of air exclusion. It is theorized, without being bound, that as the outer layer on a mass of the composition rapidly cools, it applies pressure to subsurface materials thereby driving out any included air. The same function is expected if the composition were to be prepared under gasses other than air. In addition, since metals are electrical conductors, the powdered metal also allows static electrical charge dissipation, thereby preventing the build up of static charge on a composite. This added advantage of static charge dissipation is a useful feature in some composite applications.

In order to perform its function, the powder is preferably within a certain size range, which may be dependent upon the nature of the powder. Thus, for example, powdered aluminum, one of the preferred powders, is preferably sized so that the bulk of the particles are in the size range 25 to 60 microns. On the other hand, titanium oxide, also a preferred powder is preferably in the size range of up to 1 micron. Thus, size is not critical, and depends upon the nature of the metal or metal oxide being used.

The quantity of powder to be added depends to some extent upon the nature of the polymer mixture and the type of powder. However, in general, the amount of powder, based upon the weight of the polymer mixture and the powder, is from about 5 to about 15 wt. %, and most preferably about 10 wt. %.

A variety of powdered materials may be used to perform the finctions described herein. While the most preferred powders are aluminum and titanium oxide, other like powders might also be expected to function well in the compositions of the invention. Examples include, but are not limited to aluminum oxide, silicon dioxide, zirconium dioxide, titanium carbide, and silicon carbide.

A method of preparing an embodiment of the composition according to the invention includes selecting suitable amounts of the fatty acid esters and paraffins for the mixture, and heating the mixture to its melting point to produce a liquid. A predetermined amount of powder of a selected type is added to the liquid hydrocarbon, and mixed in while minimizing air entrainment into the liquid mass. After mixing, the liquid mixture is rapidly cooled, for example by placing into a cold freezer or refrigerator preferably at or near about 32° F. (0° C.). During cooling, the solidification of the outer surfaces of the mixture mass, and its contraction, compresses the interior portion, and expels any entrained air. The solidified mass is then preferably pulverized for ease of subsequent use to coat a substrate, such as a composite structure.

The coating of the invention may be applied by any of a variety of conventional techniques. Preferably, no solvent is added to the composition because solvents produce volatile organic compounds (“VOCs”) into the atmosphere when they evaporate, and are therefore environmentally objectionable. Further, even if drying of a coating with solvent added were in a controlled environment where VOCs were captured, solvent evaporation could produce pinholes in the resulting coating. Accordingly adding solvent is disfavored. The composition is preferably applied solvent free. If it is liquefied by heating, it can be applied by spraying, brushing on or applying with rollers, or any other conventional means of coating application.

Coating thickness may vary depending upon the nature of the composite substrate, the conditions to which the coated substrate will be exposed, and the particular polymer mixture used in the coating composition. Coating thickness will also vary based on the method of application. In general, however, a coating thickness of at least about 0.05 mm would be suitable for most applications. It is noted that the coating itself does not change weight (i.e. gain or lose moisture).

In solid form, the composition is waxy, and the addition of titanium oxide as a powdered additive cases its color to be white. This permits application of a colored coating to the composite substrate which may be advantageous in certain applications. Of course, other coloring additives may be added as well, if desired. The use of metallic powder, on the other hand, provides a metallic appearance. Thus, aluminum powder results in a composition that has an aluminum metallic sheen.

The coating composition is chemically stable, eliminates static charge build up (when a conductive powder is used), and is nonreactive with composite substrate materials. Accordingly, it may be applied on a wide range of composite substrate materials, and indeed, on other materials as well to minimize or prevent moisture absorption. The coating may be removed by a variety of means, for example, by dissolving it with suitable chemicals, such as detergents or solvents, or by mechanical scraping off and polishing with a suitable brush or other instrument, or by applying heat to melt the coating and wiping it off, or by a combination of these methods.

The coating compositions of the invention will provide protection against loss of residual moisture present in a composite that is effective for long periods of time, if the coatings are not subject to processes that damage or remove them. The coatings can be repaired if damaged or reapplied, from time to time, as needed to maintain the moisture protection/retention barrier they provide.

The above description of embodiments of the invention is not limiting of the invention as encompassed in the claims here below. Any modifications to the described invention, that may be obvious to a person of skill in the art, are encompassed within the scope of equivalents of the claimed invention.

1. A coating composition for substantially preventing moisture loss from a cured composite coated with the composition, the coating composition comprising:
a) a mixture comprising waxes and paraffins; and
b) a powdered metal, metal oxide, or metal carbide dispersed throughout the mixture;
wherein the coating reduces moisture loss from the composite coated therewith, and wherein the composite comprises residual moisture produced by a cure reaction.

2. The coating composition of claim 1, wherein the mixture comprises a mixture of beeswax and paraffins.

3. The coating composition of claim 2, wherein the paraffins comprise primarily aliphatic hydrocarbons having chain lengths in the range from about 18 to about 36 carbon atoms.

4. The coating composition of claim 1, wherein the metal comprises aluminum.

5. The coating composition of claim 1, wherein the metal oxide comprises titanium oxide or aluminum oxide.

6. The coating composition of claim 2, wherein the metal comprises aluminum.

7. The coating composition of claim 2, wherein the metal oxide comprises titanium oxide or aluminum oxide.

8. The coating composition of claim 1, wherein the mixture, before addition of powdered metal or metal oxide, has a melting point in the range of about 120° to 250° F.

9. The coating composition of claim 1, wherein, the composition cools to ambient temperature substantially free of occlusion of gas bubbles.

10. The coating composition of claim 1, wherein the composition is a solid at temperatures in the range below about 120° F., and liquefies upon heating to a temperature in the range from about 140° to about 180° F.

11. The coating composition of claim 1, wherein the powdered metal or metal oxide or metal carbide comprises a sufficient amount to permit uniform heating of a mass of the composition, and to provide such internal compression of a mass of the composition upon cooling as to substantially exclude occluded gasses from a cooled mass.

12. The coating composition of claim 1, wherein the amount of powdered metal or metal oxide or metal carbide comprises from about 5 to about 15 wt. %, based on the weight of the mixture of paraffin and beeswax.

13. The coating composition of claim 1, wherein when coated onto a composite material subject to residual moisture loss, the composition reduces moisture loss by from about 60 to about 100% as compared to an uncoated composite.

14. A coating composition for substantially preventing development of cracks in a cured composite, the composite otherwise prone to moisture loss under environmental conditions to which it is exposed, the composition comprising:
a) a mixture of esters of fatty acids and aliphatic hydrocarbons having a softening point in the range from about 120° to about 180° F.; and
b) a powdered additive in sufficient amount to permit uniform heating of a mass of the composition and to provide compression of a mass of the composition upon cooling sufficient to substantially exclude occluded gasses from a cooled mass;
wherein the composite comprises residual moisture resulting from cure of a polymer of the composite.

15. The coating composition of claim 14, wherein the mixture comprises paraffins and waxes, the paraffins primarily having a chain length of from about 18 to about 36 carbon atoms.

16. The coating composition of claim 14, wherein the powdered additive is selected from the group consisting of powdered metals, metal carbides and metal oxides.

17. The coating composition of claim 15, wherein the powdered additive comprises powdered aluminum comprising particulates in the range from about 25 to about 60 microns.

18. The coating composition of claim 16, wherein the powdered additive is selected from aluminum and titanium oxide.

19. The coating composition of claim 14, the composition comprising a solid at ambient temperatures in the range below about 120° F.

20. The coating composition of claim 14, wherein when coated onto a composite material subject to moisture absorption under ambient conditions of temperature and humidity, the composition reduces moisture absorption by from about 60 to about 100%.
